(19) United States
(12) Patent Application Publication
(10) Pub. No.: US 2009/0110135 A1
(43) Pub. Date: Apr. 30, 2009

(54) Methods for PRS-Based Symbol Timing Adjustment for OFDM Systems

(75) Inventors: Jianxuan Du, San Jose, CA (US); Yue Chen, Fremont, CA (US); Baoguo Yang, San Jose, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/258,362

(22) Filed: Oct. 24, 2008

Related U.S. Application Data
(60) Provisional application No. 60/982,363, filed on Oct. 24, 2007.

(51) Int. Cl. H04L 7/00

(52) U.S. Cl. 375/371

(57) ABSTRACT

This invention relates to methods for determining symbol timing shift for a received signal, comprising the steps of: demodulating a received signal; removing a phase reference sequence from the demodulated signal to generate a channel frequency response; converting said channel frequency response to the time domain to generate a channel impulse response; determining a detection threshold; determining a first path and a last path as a function of the detection threshold; and calculating a timing shift as a function of the first path and the last path.

### CROSS REFERENCE

This application claims priority from a provisional patent application entitled “PRS-Based Symbol Timing Adjustment in DAB/T-DMB” filed on Oct. 24, 2007 and having an Application No. 60/982,363. Said application is incorporated herein by reference.

### FIELD OF INVENTION

This invention relates to methods for demodulating an orthogonal frequency division multiplexing (OFDM) signal. In particular, this invention relates to methods for timing synchronization for a received OFDM signal.

### BACKGROUND

Orthogonal frequency division multiplexing system is a multi-carrier transmission technique that uses orthogonal subcarriers to transmit information within an available spectrum. Since the subcarriers may be orthogonal to one another, they may be spaced much more closely together within the available spectrum than, for example, the individual channels in a conventional frequency division multiplexing (FDM) system. Many modern digital communications systems are turning to the OFDM system as a modulation scheme for signals that need to survive in environments having multipath-propagation or strong interference, including the IEEE 802.11a standard, the Digital Video Broadcasting Terrestrial (DVB-T) standard, the Digital Video Broadcasting Handheld (DVB-H) standard, the Digital Audio Broadcast (DAB) standard, and the Digital Television Broadcast (T-DMB) standard.

In an OFDM system, the subcarriers may be modulated with a low-rate data stream before transmission. It is advantageous to transmit a number of low-rate data streams in parallel instead of a single high-rate stream since low symbol-rate schemes suffer less intersymbol interference (ISI) caused by multipath.

OFDM modulated signals can be transmitted in transmission frames, where each transmission frame consists of a number of symbols. The reception of these signals depends on successful acquisition of symbol timing and frame timing. Symbol timing acquisition can be accomplished by finding the boundary of each symbol; whereas frame timing acquisition can be accomplished by finding the starting symbol of each transmission frame.

In particular, for DAB systems the first symbol of each transmission frame is a NULL symbol, where no signal is sent. The NULL symbol is followed by a symbol with a known modulated sequence, such as a phase reference symbol (PRS). The NULL symbol is used for frame timing and coarse synchronization. Whereas the PRS can be used for fine synchronization.

Each symbol is further divided into a guard interval (GI) and a valid symbol interval (VSI). A copy of a predetermined portion of the VSI can be inserted into the GI to prevent inter-symbol interference. For instance, a cyclic prefix can be placed into the GI.

However, with respect to OFDM modulated signals, timing synchronization and frequency synchronization are difficult. It is difficult to exactly synchronize symbols between the transmitter and the receiver. Timing synchronization requires that the beginning of each OFDM symbol be determined within each frame. Unless the correct timing is known, the receiver cannot remove cyclic prefixes at the correct timing instance. Thus, individual symbols cannot be correctly separated before fast Fourier transforms are performed to demodulate the signal.

Therefore, it is desirable to provide methods for timing synchronization for OFDM modulated signals.

### SUMMARY OF INVENTION

An object of this invention is to provide methods for timing synchronization, where a sample interval is located for computing a noise variance relative to a strongest path for better immunity against abrupt channel variation.

Another object of this invention is to provide methods for timing synchronization, where a detection threshold can be used for timing adjustments to avoid abrupt timing jitter caused by low signal power of a PRS.

Yet another object of this invention is to provide methods for timing synchronization, where a timing backoff is introduced to accommodate sampling clock drift in each transmission frame.

Briefly, this invention relates to methods for determining symbol timing shift for a received signal, comprising the steps of: demodulating a received signal; removing a phase reference sequence from the demodulated signal to generate a channel frequency response; converting said channel frequency response to the time domain to generate a channel impulse response; determining a detection threshold; determining a first path and a last path as a function of the detection threshold; and calculating a timing shift as a function of the first path and the last path.

An advantage of this invention is that methods for timing synchronization are provided that have better immunity against abrupt channel variation.

Another advantage of this invention is that abrupt timing jitters are avoided during timing synchronization by using a detection threshold.

Yet another advantage of this invention is that a timing backoff is introduced to accommodate sampling clock drift in each transmission frame during timing synchronization.

### DESCRIPTION OF DRAWINGS

The foregoing and other objects, aspects, and advantages of the invention will be better understood from the following detailed description of the preferred embodiment of the invention when taken in conjunction with the accompanying drawings in which:

FIGS. 1a-1b illustrate a process flow for timing synchronization.

FIG. 2 illustrates the resultant channel impulse response in the frequency domain of a transmission frame after interpolation of the data carriers.

FIG. 3 illustrates the channel impulse response in the time domain of a transmission frame.

FIG. 4 illustrates the relationship between the detection threshold, Nₚₐₜₕ, and the absolute magnitude of the channel impulse response, |hₙ|.

### DETAILED DESCRIPTION OF THE PREFERRED EMBODIMENTS

Once signal acquisition is achieved, signal reception begins from the next transmission frame. For each transmission frame, fine timing synchronization is performed using the PRS in the synchronization channel, such that a fast Fourier transform (FFT) window can be properly positioned for minimum inter-symbol interference.

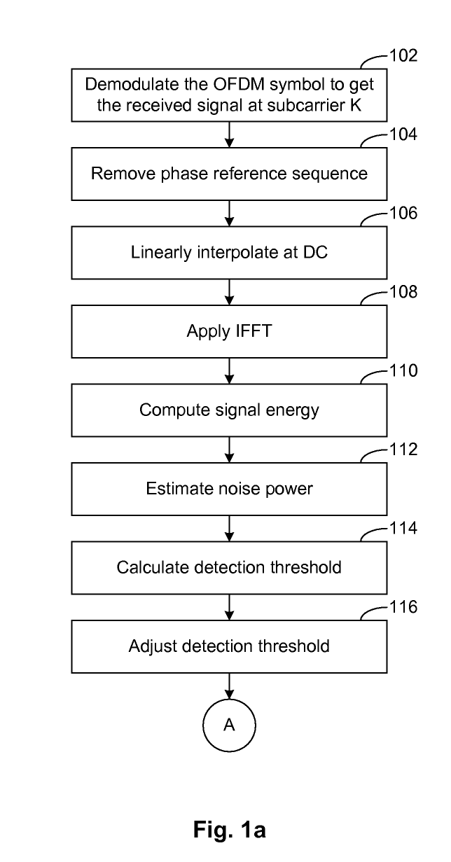

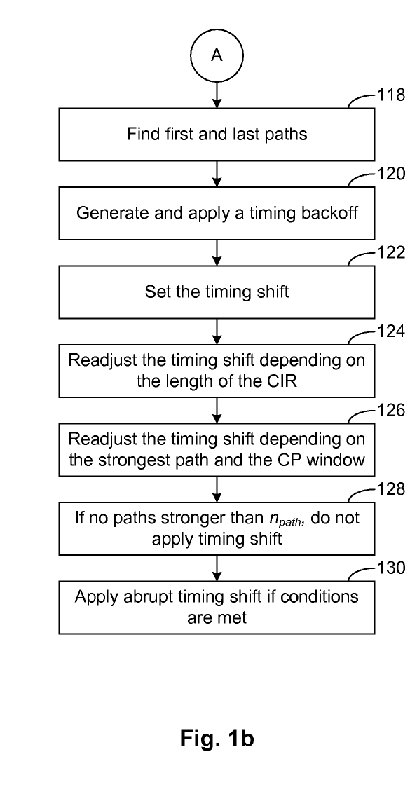

FIGS. 1a-1b illustrate a process flow for fine timing synchronization. The fine-frequency-corrected PRS signal can be denoted, \tilde{x}[n], where n corresponds to a sample count of a received signal. An OFDM symbol is demodulated 102 by cyclic prefix removal and FFT to get the received signal at subcarrier k,

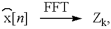

where Zₖ is the received signal at subcarrier k (1)

The phase reference sequence can then be removed 104 from the observed PRS symbol in the frequency domain,

$${H}_{k} = {{z}_{k} ( {\overline{z}}_{k} )}^{*} , for - \frac{K}{2} \leq k \leq \frac{K}{2} - 1 , k \neq 0. \qquad ( 2 )$$

where K is a number of used subcarriers for a respective mode.

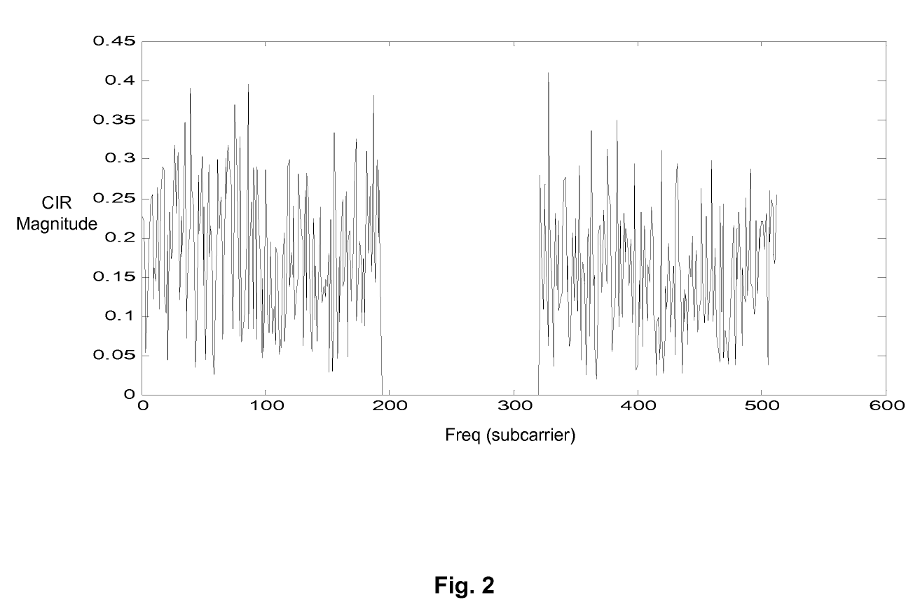

Next, a data carrier (DC) can be linearly interpolated 106 by using, H₀=(H₋₁+H₁)/2. The resultant channel frequency response is illustrated in FIG. 2.

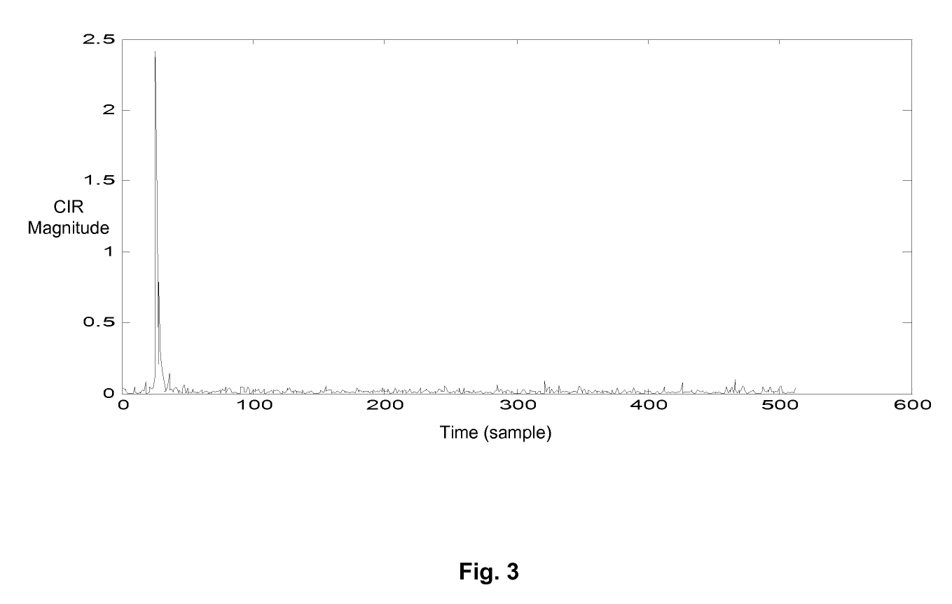

Referring back to FIG. 1, the channel response can be converted to the time domain by applying Inverse Fast Fourier Transform (IFFT) 108, with the result hₙ, illustrated in FIG. 3.

Once again referring back to FIG. 1, the signal energy, pᵢ, can be computed 110 for every M samples, where M is a positive integer.

$${p}_{i} = {\sum }_{j = 0}^{M - 1} {\vert {h}_{iM + j} \vert}^{2} , i = 0 , 1 , … , ( FFTSize / M ) - 1 \qquad ( 3 )$$

In Equation (3), the FFTSize depends on the mode of the system. In particular for the T-DMB and the DAB standards, there are four modes, mode I, II, III, and IV. For system mode I, II, III, and IV, FFTSize can be 2048, 512, 256, and 1024, respectively; and the CPs can be 504, 126, 63, and 252, respectively. Using Equation (3), the strongest path p* at i* can be found. Therefore, the sample location of the corresponding path can be Iₘₐₓ=i*M.

The noise power can be estimated 112 by,

$${σ}_{n}^{2} = \frac{2}{{lim}_{up} - {lim}_{low}} {\sum }_{l = {lim}_{low}}^{{lim}_{up} - 1} {\vert {h}_{( {i}_{max} + l ) mod FFTSize} \vert}^{2} \qquad ( 4 )$$

where limᵤₚ>lim_{low}>0.

The detection threshold, ηₚₐₜₕ, can be calculated 114 by

$${η}_{path} = K \cdot {σ}_{n}^{2} {10}^{\frac{{α}_{path}}{10}} \qquad ( 5 )$$

where K is due to the energy of each contributing path in the frequency domain that is concentrated in the time domain; thus allowing a higher threshold for larger FFT sizes. Note that the estimated noise variance can be used for computing a soft metric, necessary for Viterbi decoding throughout the current transmission frame. Also, the AGC gain difference between the PRS symbol and the symbols at the time of demodulation should be taken into account.

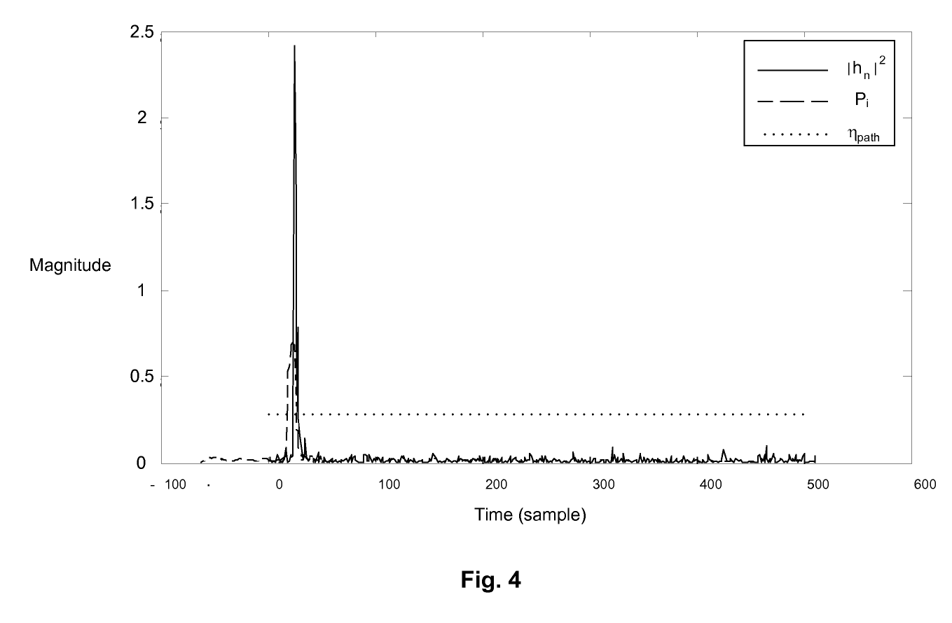

FIG. 4 illustrates the relationship between the detection threshold, Nₚₐₜₕ, and the absolute magnitude of the CIR, |hₙ|.

Referring back to FIG. 1a, to avoid underflow in case of high SNR's, the detection threshold is adjusted 116 according to the strongest path as follows:

$${η}_{path} = max \{ K \cdot {σ}_{n}^{2} {10}^{\frac{{α}_{path}}{10}} , {p}^{*} {10}^{\frac{{α}_{rel}}{10}} \} \qquad ( 6 )$$

such that the detection threshold is no less than αᵣₑₗ dB lower than the strongest path.

Using signal energies, pᵢ's, computed by Equation (3), a first path and a last path that are greater than the detection threshold, ηₚₐₜₕ, at Iₗₐₛₜ and Iₗₐₛₜ can be found 118. Next, the corresponding length of channel impulse response, I_{CIR}, can be determined.

To accommodate sampling clock error, a timing backoff, T_{backoff} can be used 120 when possible. The amount of backoff should be the maximum sample clock drift during a transmission frame, which is determined by the maximum sampling clock error and the duration of a transmission frame.

Next, a timing shift, Δt, can be set 122. If there are no paths stronger than the detection threshold, ηₚₐₜₕ, the timing shift, Δt, can be set to Δt=Iₘₐₓ−T_{backoff}. Otherwise, the timing shift can be set to Δt=I₁ₛₜ−T_{backoff}.

When the length of the channel impulse response, I_{CIR}, is too long, the timing shift can be readjusted 124. For instance, if I_{CR}>CP, the timing shift can be set to Δt=I₁ₛₜ. Otherwise, the timing shift can be set to Δt=I₁ₛₜ−(CP−I_{CR})/2.

To avoid the case where the strongest path is close to the CP boundary or outside the CP window, further adjustment 126 may be needed. The CP window can be the cyclic prefix after fine timing. For instance, if Δt+CP−1<Iₘₐₓ+T_{backoff}, then the timing shift, Δt, can be set to Iₘₐₓ−CP+1+T_{backoff}. Else, if Δt+T_{backoff}>Iₘₐₓ, then the timing shift can be set to Δt=Iₘₐₓ−T_{backoff}.

If there are no paths greater than the detection threshold, ηₚₐₜₕ, the timing shift may not be applied 128.

However, if absolute value of the timing shift is greater than the cyclic prefix, i.e. |Δt|>CP, and the strongest path is greater than the detection threshold, ηₚₐₜₕ, an abrupt timing shift can be applied 130. To avoid unnecessary timing jitter, the abrupt timing shift may not be applied until abrupt timing shifts in the same direction are produced by PRS-based fine timing in several consecutive transmission frames. Where the timing sift is greater than zero, i.e. Δt>0, the timing shift can be set to Δt=Iₗₐₛₜ+T_{backoff}−CP+1 and the adjusted timing shift can be applied.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for determining symbol timing shift for a received signal, comprising the steps of:
demodulating a received signal;
removing a phase reference sequence from the demodulated signal to generate a channel frequency response;
converting said channel frequency response to the time domain to generate a channel impulse response;
determining a detection threshold;
determining a first path and a last path as a function of the detection threshold; and
calculating a timing shift as a function of the first path and the last path.

2. The method of claim 1 further including the step of finding a strongest path and its location from a plurality of path power computed from the channel impulse response after the converting step.

3. The method of claim 2 wherein a noise power is determined relative to the location of the strongest path.

4. The method of claim 3 wherein the detection threshold is determined as a function of the noise power.

5. The method of claim 4 wherein the detection threshold is adjusted as a function of the strongest path.

6. The method of claim 1 wherein the timing shift is adjusted as a function of a sampling clock error.

7. The method of claim 2 wherein the timing shift is adjusted as a function of the location of the strongest path and a cyclic prefix.

8. The method of claim 1 wherein the timing shift is adjusted as a function of one or more timing shifts of previous frames.

9. The method of claim 2 wherein the timing shift is adjusted as a function of the detection threshold and the strongest path.

10. The method of claim 1 wherein in the determining a first path and a last path step, a length for the channel impulse response is also determined as a function of the detection threshold.

11. The method of claim 10 wherein in the calculating a timing shift step, the timing shift is also calculated as a function of the length of the channel impulse response.

12. A method for determining symbol timing shift for a received signal, comprising the steps of:
demodulating a received signal;
removing a phase reference sequence from the demodulated signal to generate a channel frequency response;
converting said channel frequency response to the time domain to generate a channel impulse response;
finding a strongest path and its location from a plurality of path power computed from the channel impulse response;
determining a detection threshold;
determining a first path, a last path, and a length for the channel impulse response as a function of the detection threshold; and
calculating a timing shift as a function of the first path, the last path, and the length of the channel impulse response.

13. The method of claim 12 wherein a noise power is determined relative to the location of the strongest path.

14. The method of claim 12 wherein the detection threshold is determined as a function of the noise power.

15. The method of claim 14 wherein the detection threshold is adjusted as a function of the strongest path.

16. The method of claim 12 wherein the timing shift is adjusted as a function of a sampling clock error.

17. The method of claim 12 wherein the timing shift is adjusted as a function of the location of the strongest path, a cyclic prefix, one or more timing shifts of previous frames, the detection threshold, and the strongest path.

18. The method of claim 14 wherein the timing shift is adjusted as a function of the location of the strongest path, a cyclic prefix, one or more timing shifts of previous frames, the detection threshold, and the strongest path.

19. A method for determining symbol timing shift for a received signal, comprising the steps of:
demodulating a received signal;
removing a phase reference sequence from the demodulated signal to generate a channel frequency response;
converting said channel frequency response to the time domain to generate a channel impulse response;
finding a strongest path and its location from a plurality of path power computed from the channel impulse response, wherein a noise power is determined relative to the location of the strongest path;
determining a detection threshold as a function of the noise power, wherein the detection threshold is adjusted as a function of the strongest path;
determining a first path, a last path, and a length for the channel impulse response as a function of the detection threshold; and
calculating a timing shift as a function of the first path, the last path, and the length of the channel impulse response, wherein the timing shift is adjusted as a function of a sampling clock error, the location of the strongest path, a cyclic prefix, one or more timing shifts of previous frames, the detection threshold, and the strongest path.
